(19) United States
(12) Patent Application Publication
(10) Pub. No.: US 2005/0173946 A1
(43) Pub. Date: Aug. 11, 2005

(54) Openable vehicle roof

(75) Inventors: Rainer Grimm, Frankfurt (DE); Horst Bohm, Frankfurt (DE); Thomas Becher, Rodgau (DE); Holger Oechel, Frankfurt (DE)

Correspondence Address: CARLSON, GASKEY & OLDS, P.C., 400 WEST MAPLE ROAD, SUITE 350, BIRMINGHAM, MI, 48009, US

(73) Assignee: ArvinMeritor GmbH

(21) Appl. No.: 11/043,727

(22) Filed: Jan. 26, 2005

(30) Foreign Application Priority Data
Feb. 11, 2004 (DE) 10 2004 006 736.8

(51) Int. Cl. B60J 7/047

(52) U.S. Cl. 296/220.01

(57) ABSTRACT

An openable vehicle roof including a shiftable cover has a central drive for the shiftable cover in an area of a central strut. Mounted to lateral edges of the shiftable cover are struts which reinforce the shiftable cover and form a continuation of vehicle roof struts.

### RELATED APPLICATIONS

The application claims priority to German Application No. 10 2004 006 736.8, which was filed on Feb. 11, 2004.

### BACKGROUND OF THE INVENTION

The invention relates to an openable vehicle roof, comprising at least one selectively shiftable cover for selectively opening and closing a roof opening, and which includes a central strut extending along a middle of a vehicle to divide the roof opening into two halves, with the central strut having a drive for the shiftable cover.

Vehicle roofs with such covers may also be referred to as spoiler roofs having a central drive. Rather than being driven along two lateral edges, the cover is driven only in a region of the center, more specifically along the so-called “central strut.” This type of vehicle roof is particularly suitable for roadsters.

It is the object of the invention to provide a vehicle roof that has a high stability while still having a large roof opening in terms of surface area.

### SUMMARY OF THE INVENTION

A vehicle roof includes a cover with longitudinal edges, as viewed in a longitudinal direction of a vehicle, which have struts mounted thereto. The struts have a reinforcing effect and form a continuation of lateral roof struts of the vehicle. The struts border on the lateral roof struts provided on a part of the vehicle roof fixed to the vehicle, and stabilize the cover, which has a larger width than conventional covers. The width may be increased in that laterally to the cover, the vehicle roof has a narrower roof strut or, in accordance with the preferred embodiment, has no roof strut at all.

The invention is especially advantageous when employed in combination with doors having no window frame. As a result, when the cover is shifted to the rear, an occupant will feel as if they are driving or riding in a convertible, because there is no upper side window frame to obstruct the occupant's upward view.

Accordingly, side windows are in direct contact with the cover, which in this embodiment is preferably provided with appropriate window seals.

In the present invention, the cover has an outer wall extending across an area that supplements an outer skin. The outer wall preferably is a glass or plastic material having a curvature that is adapted to the outer skin. According to the invention, the outer wall is provided with a foam backing or an injection-molded backing in a region of lateral edges, and preferably in this region only. The foam backing or injection-molded backing increases stability and allows an easy integration of the struts and, where appropriate, the window seals.

The struts are made of metal, and are preferably comprised of bent sheet metal components. The struts may be embedded into the foam backing or injection-molded backing in a very simple manner, making a complicated fitting of the struts to the curved glass cover unnecessary.

The vehicle roof according to the present invention can be designed to have a cover forming a unit that is removable without a tool. This means that the cover may, on the one hand, be shifted and, on the other hand, be completely removed from the vehicle roof, to be stowed, for example, behind seats or in a trunk.

The cover and a central strut (along with a drive, where appropriate) may also be designed as a joint unit that is removable without a tool so that, with the cover in the removed condition, not even the central strut will obstruct the upward view.

In contrast to a conventional spoiler roof having a central drive, the invention provides devices for locking with a stationary portion of the vehicle roof are provided at all four corners of the cover. “Stationary” in this connection means “non-movable.” This is intended to produce a high stability of the vehicle roof and thus of the vehicle cover in the closed condition.

In one example, lateral guides are provided at rear corners for coupling the rear corners to a stationary portion of the vehicle roof. This will increase positional stability of a raised and shifted cover.

In order to be able to remove the unit comprised of the cover, or of the cover and the central strut, without the use of tools from the roof, the lateral guides should also be adapted to be unlocked without a tool. In one example, the lateral guides are designed as hook-out levers running in rails.

In accordance with the preferred embodiment, the cover, the central strut, and a stationary portion of the vehicle roof adjoining the cover in the longitudinal direction of the vehicle, constitute a preassembled roof module unit. The preassemble roof module unit is placed onto a roof frame, of which sections are provided, and is permanently attached to the roof frame, in particular by bonding.

These and other features of the present invention can be best understood from the following specification and drawings, the following of which is a brief description.

### BRIEF DESCRIPTION OF THE DRAWINGS

FIG. 1 shows a perspective view of a vehicle roof according to the invention, with a roof opening closed.

FIG. 2 shows a perspective view of the vehicle roof of FIG. 1, with the vehicle roof in a fully opened condition.

FIG. 3 shows a bottom plan view of the vehicle roof according to the invention.

FIG. 4 shows a perspective view of the vehicle roof according to the invention in an area of a rear left-hand corner of a cover, with the cover raised and moved back.

FIG. 5 shows a view diagonally from below, in the area of the rear left-hand corner of the cover when the cover is in a locked condition.

FIG. 6 shows a perspective view of the vehicle roof in an area of a rear end of a central strut.

FIG. 7 shows a perspective view of a drive in an area of a central strut.

FIG. 8 shows a sectional view of a vehicle roof and an adjoining side window, as sectioned transversely to a longitudinal axis of a vehicle.

FIG. 9 shows a diagrammatic longitudinal sectional view of the vehicle roof in a ventilator position in which a rear edge of the cover is lifted. FIG. 10 shows a diagrammatic longitudinal sectional view of the vehicle roof in an uncoupled position.

FIG. 11 shows a diagrammatic longitudinal sectional view of the vehicle roof in a disassembled position.

FIG. 12 shows a diagrammatic longitudinal sectional view of the vehicle roof in a removed position.

### DETAILED DESCRIPTION OF THE PREFERRED EMBODIMENT

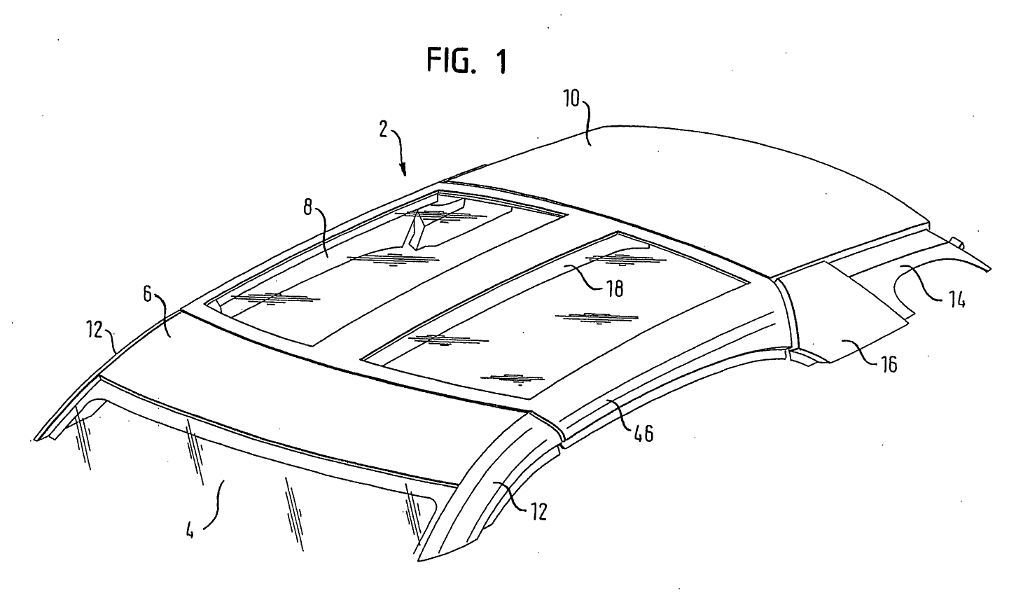

FIG. 1 illustrates a vehicle roof area of a vehicle, more specifically of a roadster. The vehicle roof area shown is a roof module 2, which is produced as a separate unit and is openable. The roof module 2 includes a stationary front portion 6 adjoining a windshield 4, a selectively shiftable cover 8 adjoining the front portion 6 in a longitudinal direction of the vehicle, and a large-area, stationary rear portion 10, which adjoins the cover 8. Outer faces of the front and rear portions 6, 10 and of the cover 8, define an outer skin of the vehicle in the roof area.

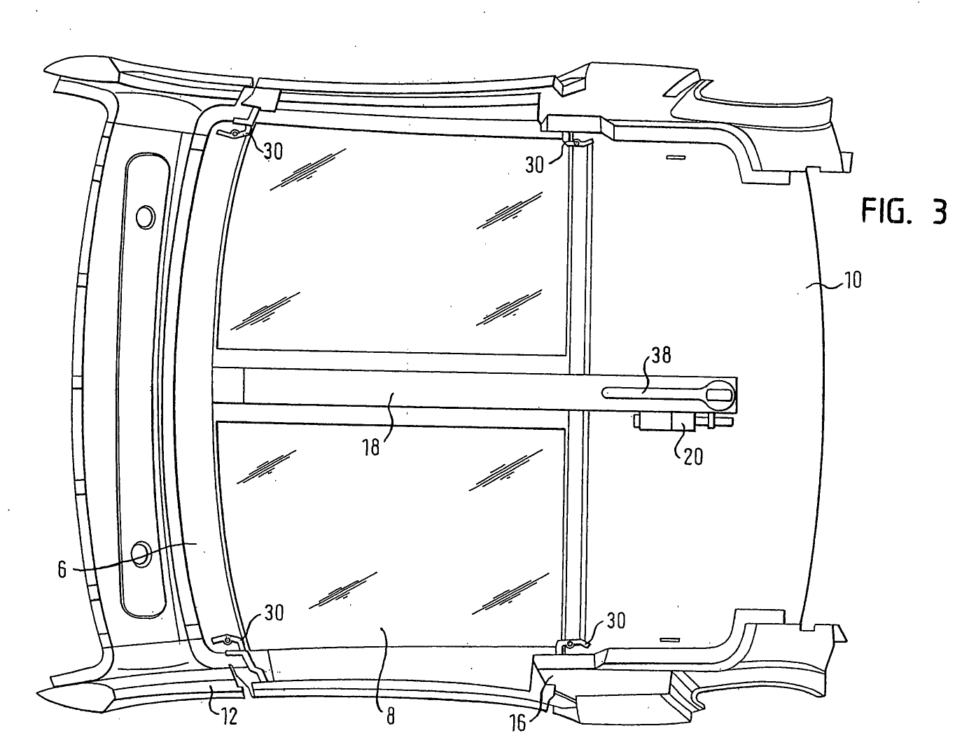

The roof module 2 is secured on a roof frame. The roof frame has two front lateral roof struts 12 that end at the cover 8 and two rear roof struts 14, which adjoin the cover 8 and merge into the B-column 16. The front lateral roof struts 12 end by free webs towards the cover 8 (see also FIG. 3).

The front and rear portions 6 and 10 of the roof module 2 are permanently connected to the front and rear lateral roof struts 12, 14 and to corresponding transverse struts (not to be denoted in more detail) by bonding so as to be non-detachable.

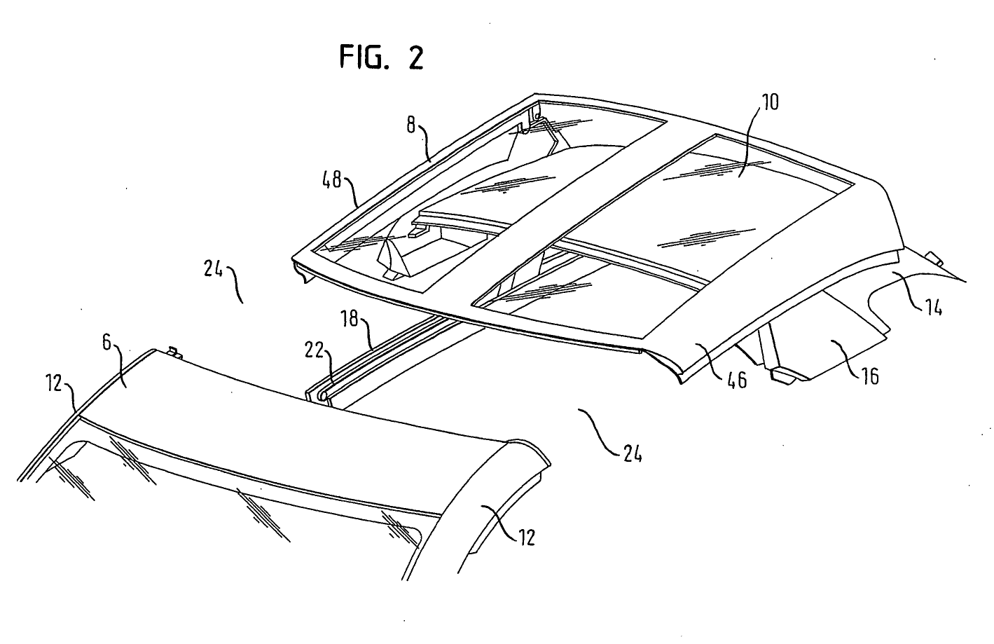

The vehicle roof illustrated is a special form of openable roof, since, unlike conventional sliding or sliding-tilting roofs, the cover 8 is not driven along two lateral edges, but only along vehicle center. For this purpose, a central strut 18 is provided that extends from the front portion 6, as far as to the rear portion 10, and which is releasably secured to the front and rear portions 6, 10. In an area of a rear end of the central strut 18 (see FIG. 3), the central strut 18 carries an electric drive 20 that drives a toothed belt 22 (see FIG. 2) extending as far as to a front end of the central strut 18. The toothed belt 22 is coupled to the cover 8, so that upon a movement of the toothed belt 22 the cover 8 can be shifted in the longitudinal direction of the vehicle.

To open the cover 8, the cover 8 is first lifted in an area of a rear edge of the cover 8 and is then shifted over the rear portion 10 (see FIG. 2), so that a roof opening 24 is exposed. The roof opening 24 is divided by the central strut 18.

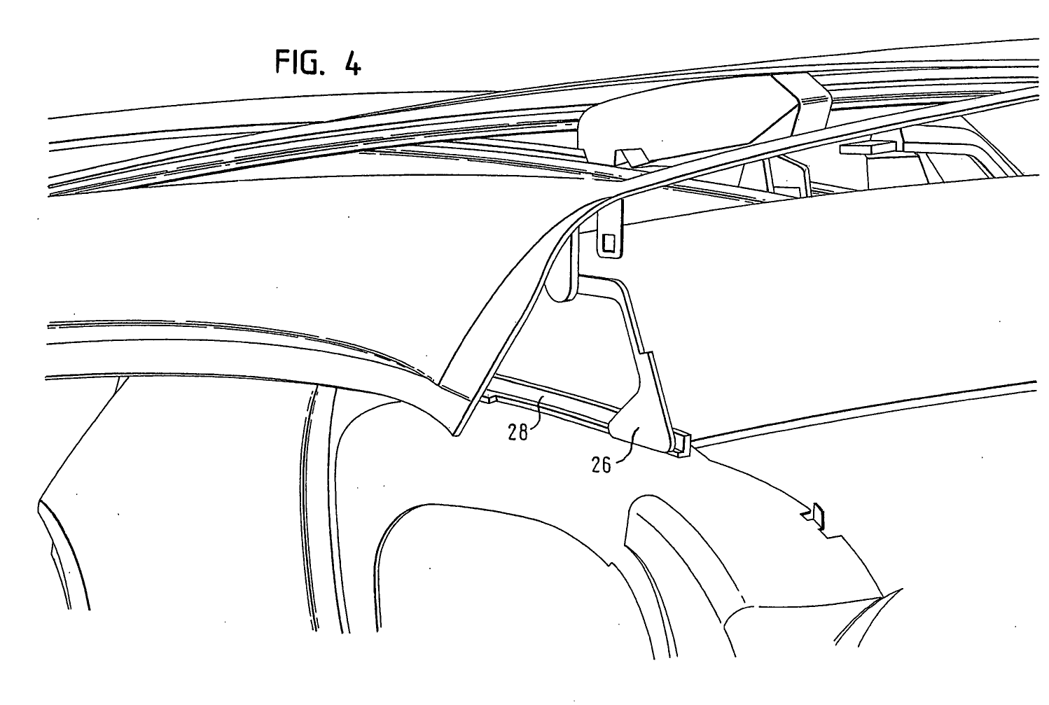

For optimum guidance of the cover 8 during shifting, lateral guides are provided in the area of rear corners of the cover 8. In one example, the lateral guides are in the form of hook-out levers 26 (see FIG. 4), which are pivotally connected to the cover 8 and are mounted in rails 28 for longitudinal displacement. The rails 28 are configured in lateral edges of the rear portion 10. As already discussed above, the rear portion 10 is a stationary portion of the vehicle roof.

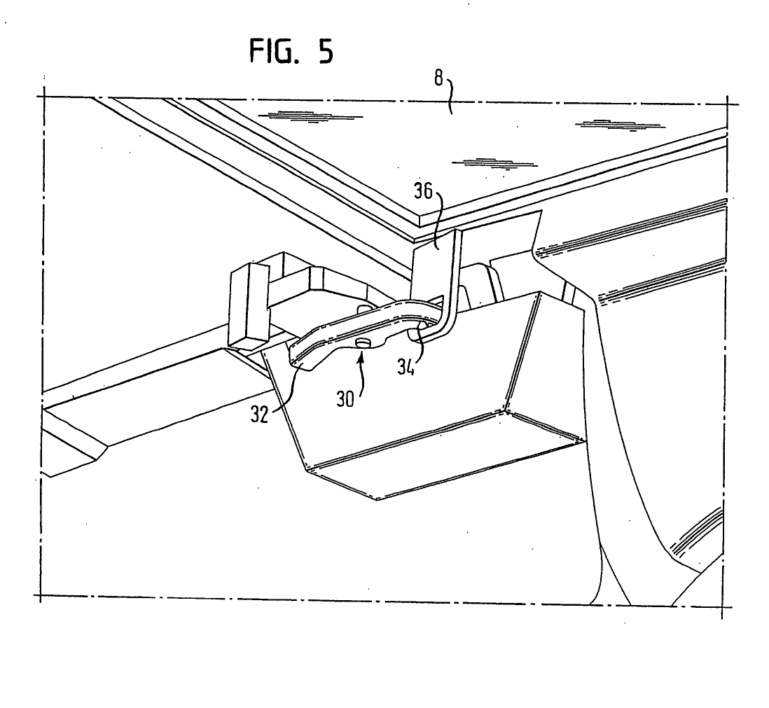

In the closed condition of the vehicle roof, the cover 8 is secured to the remaining part of the vehicle roof at all four corners by way of locking devices 30. This increases the stability of the vehicle roof by incorporating the cover 8 in a force-transmitting relationship with neighboring parts. One of the locking devices 30 is illustrated in greater detail in FIG. 5. Fitted to a lower side of the rear portion 10 (and to the front portion 6 for front locking devices 30) are pivotable two-armed levers 32. A front arm of each lever 32 is bent at right angles on one side to penetrate a loop-type opening 34 producing a locking engagement. The opening 34 is part of a downwardly bent sheet metal tab 36 that is firmly connected to the cover 8.

The locking devices 30 may be closed and/or opened manually, mechanically (e.g., by spring force) or by a motor. The locking devices 30 must be opened to displace the cover 8.

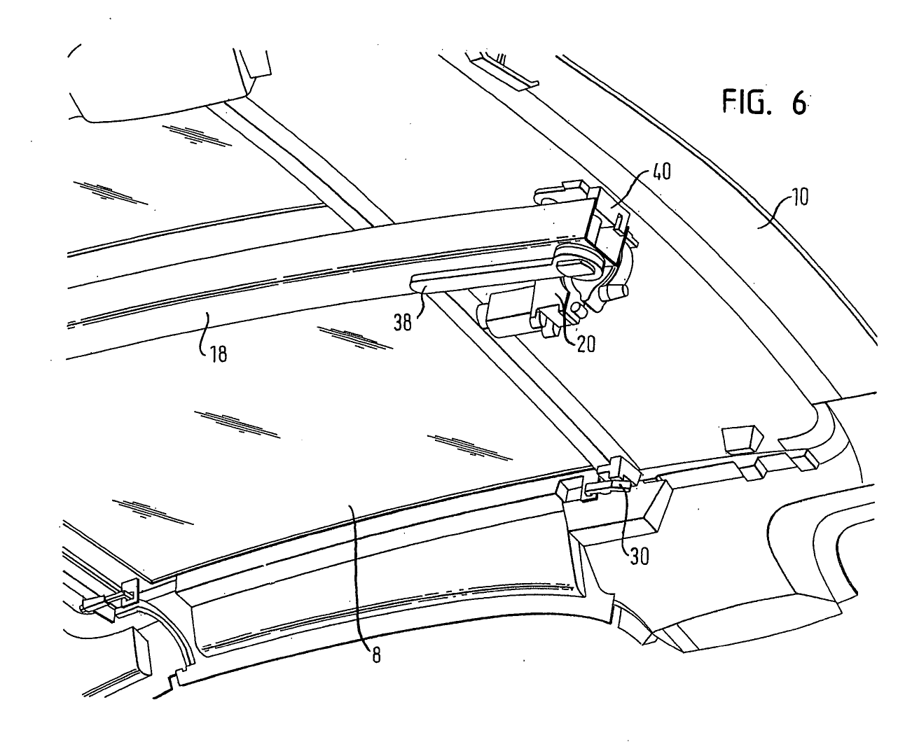

The cover 8, together with the central strut 18 and the electric drive 20 fastened thereto, constitutes a detachable unit which can be removed by a vehicle user from a remaining portion of the vehicle roof quickly and unproblematically without the use of tools. For this purpose, an unlocking lever 38 that can be pivoted through 90 degrees is provided on a lower side of the central strut 18 in the area of the rear end. In the position shown in FIG. 3, the unlocking lever 38 is in a locked position, in which the central strut 18 is connected to the rear portion 10 without clearance. Locking is effected, for example, via sliding blocks (not illustrated) at an extension 40 on the lower side of the rear portion 10 (see FIG. 6).

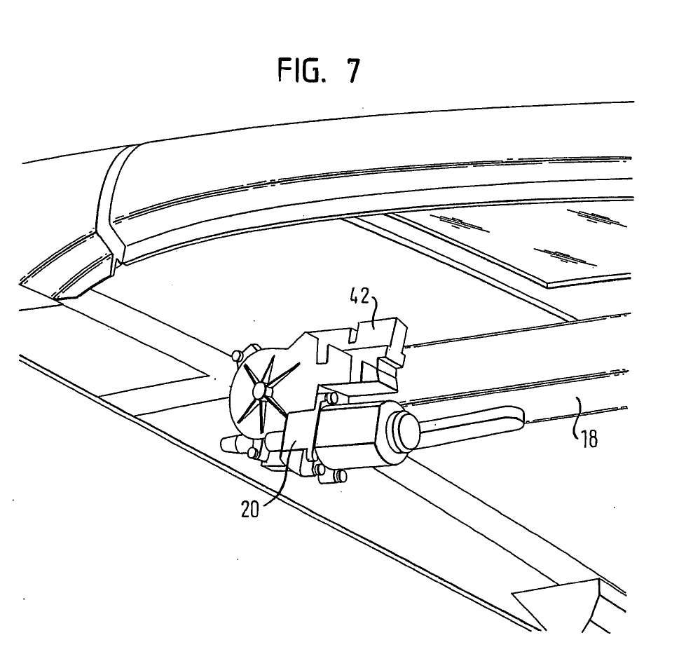

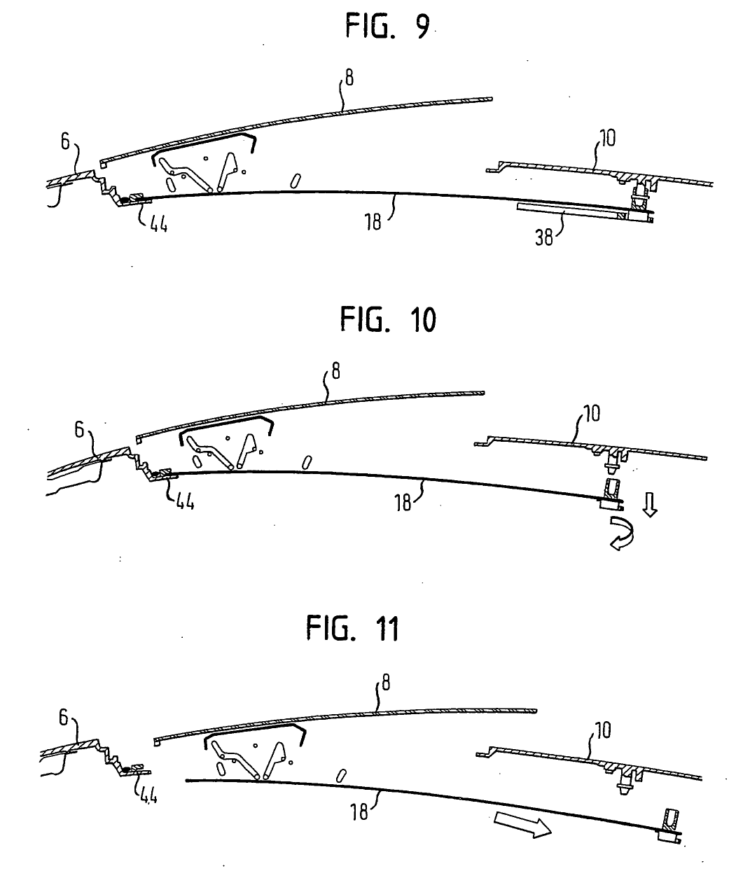

For removal of the cover 8 along with the central strut 18, the cover 8 is first shifted to a so-called “ventilator” position, in which a rear edge of the cover 8 is lifted (see FIG. 9). Then the unlocking lever 38 is rotated through 90 degrees (see FIG. 10), so that the unlocking lever 38 is uncoupled from the rear portion 10. Since the electric drive 20 receives a power supply via lines that run on the lower side of the rear portion 10, an electrical plug connection 42 that is easy to uncouple is provided between the electric drive 20 and the rear portion 10 (see FIG. 7).

After the unlocking lever 38 is pivoted, the central strut 18, together with the electric drive 20, can be slightly tilted downwards (see FIG. 10). At the front end, the central strut 18 is received in a short strut guide 44, which in turn protrudes downwards from the front portion 6 and is connected therewith. In a subsequent disassembly step, illustrated in FIG. 11, the cover 8 is slightly pulled to the rear in the direction indicated by the arrow, so that the central strut 18 is pulled out of the strut guide 44.

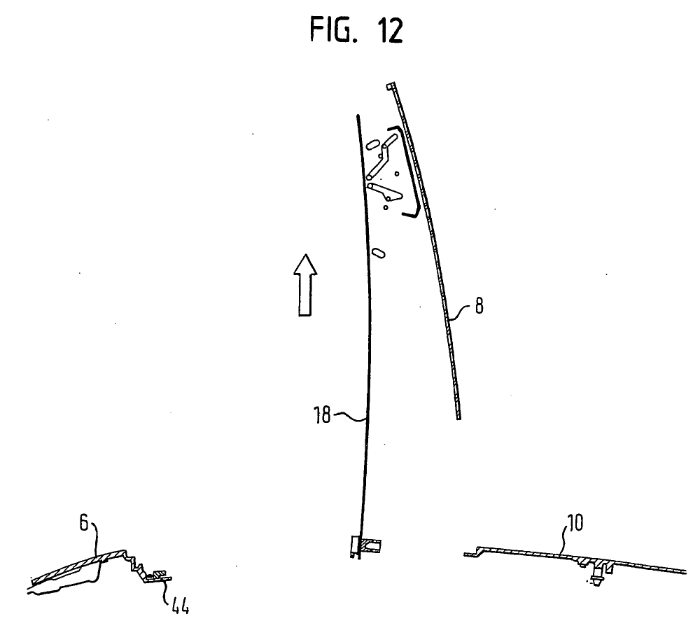

Finally, the detachable unit is pivoted upwards and out of the vehicle (see FIG. 12). This step also involves pulling the pivotable two-armed levers 32 out of the rails 28.

A special feature of the vehicle roof is the extremely large roof opening 24 that is produced both when the cover 8 is shifted, shown in FIG. 2, and also after removal of the cover 8, shown in FIG. 12. This is achieved by a special design of the cover 8 and of the roof struts. As is illustrated more particularly in FIGS. 1 and 2, the vehicle roof in fact has no roof struts in an area laterally of the cover 8. Rather, the front lateral roof struts 12 are continued by sturdy lateral edges 46 of the cover 8 in the longitudinal direction of the vehicle. The lateral edges 46 of the cover merge into the rear lateral roof struts 14.

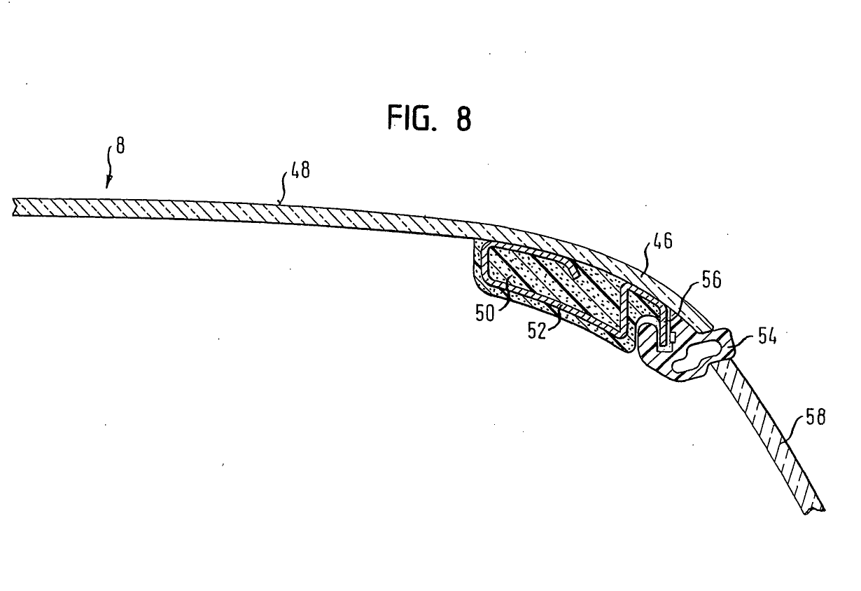

The cover 8 is a sandwich-type composite part whose structure is shown in FIG. 8. The outer skin is formed by a curved outer wall 48 made of plastic or glass. In the area of the lateral edges 46, i.e., the lateral longitudinal edges and in continuation of the front and rear lateral roof struts 12, 14, the outer wall 48 is provided with a foam backing or an injection-molded backing. Reference numeral 50 denotes a plastic material, which in forming the foam backing or injection-molded backing, is permanently fitted to a lower side of the outer wall 48. Embedded in this bead-like section made of plastic material 50 is a reinforcing insert, also referred to as cover-side strut 52. This cover-side strut 52 consists of a bent sheet metal component. In the closed condition of the vehicle roof, the cover-side strut 52 constitutes a non-positive connection between the front and rear lateral roof struts 12, 14 on each side of the cover 8. A direct frictional connection between the front and rear lateral roof struts 12, 14 and the cover-side struts 52 is produced via the locking devices 30. In other words, some sections of a traditionally provided roof strut are transferred into the cover 8.

The cover 8 has a weatherstrip-type seal 54 which is partly hollow and clamps to a free edge 56 of the sheet metal of the cover-side strut 52. The seal 54 is a seal for a side window 58. The side window 58 is in direct contact with the seal 54 (see FIG. 8) when side doors are in a frameless configuration.

It should be emphasized that it is of particular advantage to be able to couple the embodiment of the cover 8 including the integrated cover-side struts 52 to the four locking devices 30 and the removable central strut 18, but that these individual features are also particularly advantageous per se and, if required, could also be realized with differently configured designs.

Although a preferred embodiment of this invention has been disclosed, a worker of ordinary skill in this art would recognize that certain modifications would come within the scope of this invention. For that reason, the following claims should be studied to determine the true scope and content of this invention.

1. A vehicle roof, comprising:
a roof having a roof opening;
at least one selectively shiftable cover for selectively opening and closing the roof opening,
a central strut extending along a lateral middle of the roof and dividing the roof opening into two halves, the central strut having a drive for the at least one selectively shiftable cover, and wherein cover struts are mounted to lateral edges of the at least one selectively shiftable cover, the cover struts forming a continuation of lateral roof struts of the roof and reinforcing the at least one selectively shiftable cover.

2. The vehicle roof according to claim 1, wherein the cover struts comprise the sole reinforcing struts for the vehicle roof along the lateral edges of the at least one selectively shiftable cover.

3. The vehicle roof according to claim 1, including lateral seals provided on the lateral edges of the at least one selectively shiftable cover.

4. The vehicle roof according to claim 3, wherein vehicle side doors are frameless in an upper region and wherein side windows are in direct contact with the at least one selectively shiftable cover.

5. The vehicle roof according to claim 1, wherein the at least one selectively shiftable cover includes an outer wall extending across an area and supplementing a roof outer skin, the outer wall including one of a foam backing and an injection-molded backing in a region of the lateral edges.

6. The vehicle roof according to claim 1, wherein the cover struts are made of metal.

7. The vehicle roof according to claim 6, wherein the cover struts are bent sheet metal components.

8. The vehicle roof according to claim 1, wherein the cover struts are embedded in at least one of a foam backing and an injection-molded backing.

9. The vehicle roof according to claim 1, wherein the at least one selectively shiftable cover is designed as a unit that is removable from the roof opening without a tool.

10. The vehicle roof according to claims 1, wherein the at least one selectively shiftable cover and the central strut are designed as a joint unit that is removable from a roof opening without a tool.

11. The vehicle roof according to claim 1, wherein the at least one selectively shiftable cover has corners, and devices for locking with a stationary portion of the vehicle roof are provided at each corner of the at least one selectively shiftable cover.

12. The vehicle roof according to claim 1, including lateral guides at rear corners of the at least one selectively shiftable cover for coupling the rear corners to a stationary portion of the vehicle roof.

13. The vehicle roof according to claim 12, wherein the lateral guides are adapted to be unlocked for removal of the at least one selectively shiftable cover without a tool.

14. The vehicle roof according to claim 12, wherein the lateral guides are hook-out levers running in rails.

15. The vehicle roof according to claim 1, wherein the at least one selectively shiftable cover is adapted to be raised and is constructed to be rearwardly shiftable in a longitudinal direction of the vehicle over a stationary portion of the vehicle roof adjoining the at least one selectively shiftable cover.

16. The vehicle roof according to claim 1, wherein the at least one selectively shiftable cover, the central strut, and a stationary portion of the vehicle roof adjoining the at least one selectively shiftable cover at a rear of the at least one selectively shiftable cover in the longitudinal direction of the vehicle together comprise a preassembled roof module unit.
